(19) United States
(12) Patent Application Publication
(10) Pub. No.: US 2006/0144298 A1
(43) Pub. Date: Jul. 6, 2006

(54) LAURA'S MIX

(76) Inventor: Leo C. Byford, Tulsa, OK (US)

Correspondence Address: LEO BYFORD, 5244 S. IRVINGTON PLACE, TULSA, OK, 74135, US

(21) Appl. No.: 10/994,731

(22) Filed: Nov. 22, 2004

(51) Int. Cl. C04B 28/00; C04B 7/00

(52) U.S. Cl. 106/638

(57) ABSTRACT

A mix of contaminated materials, like lead, zinc, arsenic, cadmium, and other contaminated materials, that was produced from mines that has been defined by the United States Environmental Protection Agency as containing Lead, Zinc, Cadmium, water, and other hazardous and contaminated materials/contaminated substances and with bindering products that allows for the permanent placement of the contaminated mix into mines or shafts or depositories, as defined by the United States Environmental Protection Agency, CERCLA and Superfund laws and rules for the permanent closing of these structures with contaminated material and contaminated substances.

### CROSS-REFERENCES TO RELATED APPLICATIONS

U.S. Pat. No. 4,419,135 Hoge,

U.S. Pat. No. 4,746,249 Haigh

U.S. Pat. No. 5,224,595 Sugimoto

U.S. Pat. No. 4,058,405 Snyder

U.S. Pat. No. 4,257,814 Kellet

### STATEMENT REGARDING FEDERALLY SPONSORED RESEARCH AND DEVELOPMENT

LAURA'S MIX has not been aided or sponsored by any government agency or program for development.

### THE NAMES OF THE PARTIES TO A JOINT RESEARCH AGREEMENT

There is no agreement or research agreement. I, Leo Byford, am the only and sole inventor of LAURA'S MIX.

### INCORPORATION-BY-REFERENCE OF MATERIAL SUBMITTED ON A COMPACT DISC

Not Applicable.

### BACKGROUND OF THE INVENTION

1. Field of the Invention

LAURA'S MIX is a formulated mix of contaminated ore/rock/chat as defined by the EPA, contaminated sands, and contaminated water to be applied in areas where surface, sub-surface, or capsulation of contaminated material as defined by United States Environmental Protection Agency (EPA) in the CERCLA DOCKET NO. Jun. 3, 2001. in the DOCKET NO. Jun. 3, 2001, the word “Chat” means gravel-like mine or mill tailings (greater than ¼ inch diameter) plus sands #20-65 mesh size or 0.033-0.008 inches in diameter and fine tailings mean tailings less than 0-008 inches in diameter that come from waste rock or ores as material produced from mining. These materials as defined by the EPA in this docket define the materials as being contaminated with lead, zinc, cadmium and other materials hazardous and contaminated materials and are dangerous to human health and the environment. The mining ores or chat was placed in what the EPA and the Dept of Interior have described in this same document as “CHAT” piles. These chat piles have remained in place for decades and have been not only harmful to the environment, but also to human health, and as to date there has not been a formulated mix or process or any art that has the ability for using this contaminated material as a useful product and deliver this contaminated material into mines or shafts or depositories in a permanent environment and as a permanent solution for the permanent closing of these structures. LAURA'S MIX is a formulated mix that allows for the induction of these contaminated materials by either means of pumping or gravity flow into mines or shafts or depositories that are either wet or dry, and also use the contaminated water that has been allowed to stay in the mines or shafts or depositories for decades. The introduction of these contaminated materials into the mines or shafts or depositories will allow for the structures to be returned to a condition of soundness, stop the discharge of contaminated water and contaminated materials to the environment, that is in the structures and to the outside environment and watersheds, stop the fine tailings discharged, also from the chat piles, that cause harm to the environment and humans, but also allows for the return of the land to a usable condition that these chat piles and other hazardous substances that remain on the surface, from escaping into the soil, surface water, ground water, and air and stop the degradation of the environment and improve human health.

2. Background Art

The United States Environmental Protection Agency (EPA) and other government agencies and mining companies and private companies have made numerous attempts to place contaminated materials processed from mines and other materials into mines and shafts and depositories by means of several different processes and all of those processes and attempts have failed, due to the complexity of the structures, the mix of contaminated materials would cone or not be able to flow in the structures. Due to the complexity of mines and shafts and depositories and contaminated water in the structures, the processes that were used did not allow for the displacement of water in the mines or shafts or have the ability to use pressure material pumps to place these contaminated materials into the mines or shafts or depositories as a permanent remedy. LAURA'S MIX provides a formulated mix that allows contaminated materials, like lead, zinc, cadmium, contaminated soils and other hazardous material contained in ore/rock/chat and tailings located at mine sites, to be returned to mines or shafts depositories as a permanent remedy to both surface and sub-surface hazardous contamination from mining works whether the mine workings have limited access and/or to dangerous for workers at the mine workings or depositories. LAURA'S MIX not only provides a formulated mix of contaminated materials, but also allows other products to be introduced into LAURA'S MIX as fillers, like contaminated soils, or binding agents like cement and certain kinds of lime products, or products that will enhance the pumping ability, like Plasticizer to enhance the pumping ability of LAURA'S MIX into structures whether they contain contaminated water or the structures are dry or hazardous or inaccessible that will provide permanent closure to these structures with contaminated materials as a useful product and have the ability of self leveling all in one process. LAURA'S MIX is a formulated mix that meets the complex and dangerous conditions of mines and shafts with the contaminated materials being used as a useful product that the EPA and other government agencies have deemed contaminated materials, including contaminated water, materials that cannot be sold to the general public or in retail stores because of contamination as defined by the EPA. As with reference to other patents like U.S. Pat. No. 4,419,135 Hoge, U.S. Pat. No. 4,746,249 Haigh, U.S. Pat. No. 5,224,595 Sugimoto, U.S. Pat. No. 4,058,405 Snyder, U.S. Pat. No. 4,257,814 Kellet that close mines or shafts none of those patents or mixes or slurries have present any art to use contaminated material in their slurries or mixes nor do they allow for the introduction of other fillers or compounds to be added without having some different results to their patents as stated in their patents and can be sold to the general public, but any introduction of fillers or binding agents, or Plasticizer added to LAURA'S MIX enhances the contaminated mix. The use of Plasticizer is for high range, water-reducing admixture that allows flow of mixture for longer time periods before the start of curing time for cementations materials curing process, and enables the mix the ability to be self leveling, products like Quickcrete or just cement or lime products as presented in other art previous, when water is added to that non-contaminated mixture, the curing time starts at the time water is added to the Quickcrete mixture or cement mixture the mixture acts to absorb water and by adding a displacement to the water, such as a displacing water Plasticizer, it allows for the contaminated mixture to flow and level before curing can take place. There has never been any other art that has been presented to the USPTO that has ever used a process of contaminated material as a useful product to close mines, shafts or other structures.

### BRIEF SUMMARY OF THE INVENTION

LAURA'S MIX is a formulated mix of contaminated materials that provides a permanent remedy for placing hazardous materials/substances into dangerous structures, mine structures that have limited access, structures that are deemed dangerous to work in or around that were created from mining works, as a remedy to remove contaminated material as defined by the EPA from the surface, where these contaminated materials pose and cause health threats, safety threats as a useful product. LAURA'S MIX allows for the beginning of the remediation of these contaminated lands and the returning useful event for agriculture or human habitat and also provides a method of creating a permanent solution to permanent closure of mines, shafts, and depositories. LAURA'S MIX is can also be formulated to site specific as for the each mine, shaft, or other structures has their own design and structure environments and contaminates that dictates the formulated mix that will allow contaminated material to be placed in a permanent and encapsulated environment. The binder agents such as contaminated soil, cement or lime products allow bindering of these products into one solid mass and also for containment placement. LAURA'S MIX allows for not only for the removal of contaminated materials, but also allows for the contaminated material to be used as a useful product to close mines, shafts and other structures in a permanent environment and allows the surface to be able to be return to a useful purpose all in one process. Since CERCLA and Superfund laws and rules forbids any contaminated material or products that has been declared by the Agency for Toxic Material and Substances LAURA'S MIX cannot be sold or used by the general public, but only used at sites defined by the EPA, CERCLA, and Superfund Rules and Laws, where the contaminated material is used as a useful product to permanently close structures and return land to a useful purpose. Most of these sites are within superfund boundaries and cannot be used by the general public.

### BRIEF DESCRIPTION OF THE SEVERAL VIEWS OF THE DRAWINGS

Not Applicable

### DETAILED DESCRIPTION OF THE INVENTION

LAURA'S MIX is a formulated mix of hazardous and contaminated materials, as defined by EPA and other government agencies in CERCLA DOCKET NO. Jun. 3, 2001, that uses these contaminated materials as a useful product and also allows filler materials to be introduced into the mix, whether contaminated or not, as a means of deliverability into mines or shafts or depositories , that can be pumped or gravity flowed into structures to create permanent closure for these structures and also provides encapsulation of the contaminated materials as a permanent containment environment. The Chat or gravel, as defined by the EPA, like mine or mill tailings (greater than ¼ inch diameter) plus smaller intermingled material such as sands, as defined by the EPA, (sands means #20-65 mesh size or 0.033-0.008 inches in diameter) and fine tailings, as defined by the EPA, (fine tailings mean tailings less than 0.008 inches in diameter). Chat, sands, and fine tailings, as define by the EPA, when mix together does not allow for bindering of these materials, but when formulated with cement or lime products and water, contaminated or not, and soil it becomes a contaminated binder product, defined by the EPA. This contaminated binder product is then introduced into mines or shafts or depositories and allows for the mine or shaft depositories to be the encapsulation agent and at the same time prevents the further degrading of the mine or shaft or depository, places the mine or shaft or depositories in a condition of permanent closure and also provides a environment for contaminated products to be disposed of and also provides a condition of soundness to these structures because the void of the mines is filled. A environment friendly Plasticizer is used in the pumping cycle so the mix can be delivered into these structures in extremely brief time period, allow for self leveling, and allows a cost effect method of closing voids and cracks, mines and shafts and depositories. No other mix or process has ever use contaminated material as a useful product, as a means of permanent closure of mines or mine shafts and with the ability to have bindering materials added to the contaminated mix. The basic formula is five (5) parts chat, two (2) parts sands, one (1) part cement and/or lime product, water is added as needed to blend materials, bindering agents added as needed, Plasticizer is added to meet pumping requirements and flow requirements as each mine or shaft has different requirements due to depth, width, and length and requires adjustments to the basic formulated mix that would allow deliver ability of LAURA'S MIX to target areas. Due to the fact that each mine or shaft have different dimensions and material that was removed from the earth, the basic formulated mix would require some adjustment at site location due to the volume of material that was removed from the earth and because of weigh and size of that material would also determined hindering agents as needed for the target areas. As with reference to other patents like U.S. Pat. No. 4,419,135 Hoge, U.S. Pat. No. 4,746,249 Haigh, U.S. Pat. No. 5,224,595 Sugimoto, U.S. Pat. No. 4,058,405 Snyder, U.S. Pat. No. 4,257,814 Kellet you will notice that these patents does allow for adjustment to their art mix and does not use any material or products, that have been deemed by the EPA or any other governmental agencies or federal respondents, as contaminated materials or products and these patent products also are allowed to be sold or used by the general public. LAURA'S MIX uses material or products that have been deemed by the EPA or other governmental agencies as contaminated material or products, and with bindering products, contaminated or not, will allow LAURA'S MIX to be applied to mines, shafts, or other depositories as deemed by the EPA or other governmental agencies and federal respondents as a permanent solution and permanent closure of those targeted mines or shafts or depositories. As with any contaminated products or material that has be classified by the EPA or other governmental agencies LAURA'S MIX cannot be sold or used by the general public or sold in stores like Home Depot or other retail outlets. LAURA'S MIX is site specific formulated approved and monitored for the application of permanent closing of mines, shafts, or defined depositories by the EPA or other governmental agencies or federal respondents, as a mix for permanent closing of those structures. The contaminated mix is restricted by law, CERCLA and Superfund laws and rules from being removed from site or sites unless authorize by a governmental agency who is in control of site under “CERCLA' meaning the Comprehensive Environmental Response, Compensation, and Liability Act, EPA, DOD, DOI, OHSA, DOT or any other governmental agency as classified as a Federal Respondent or has Indian Classification under BIA control.

I claim:

1. A mix or blend of fillers, Plasticizer, and Materials contaminated with Hazardous Substances as defined by the CERCLA priority list from the Agency for Toxic Substances and Disease Registry that are contained within the remaining waste of the mining industry left at various sites.

2. A contaminated mix or blend that allows for the contaminated mix or blend to be placed into voids or cracks of mines, shafts, or other depositories that is dangerous or inaccessible to workers.

3. The contaminated mix or blend allows the placing of this contaminated mix or blend into voids or cracks that are below the surface that will close void or cracks in structures permanently.

4. The contaminated mix or blend can be delivered by material pressure/hydraulic pumps to target areas.

5. The contaminated mix or blend can also be delivered by gravity flow to target areas.

6. The contaminated mix or blend allows for any target area to stabilize as the contaminated mix or blend changes from a flowable condition to a solid condition after curing has been allowed.

7. The contaminated mix or blend can be mixed on the surface as application requirements for the application to the surface or sub-surface requirements demand.

8. The contaminated mix or blend will allow for other contaminated material, like contaminated soils, contaminated liquids, contaminated rocks products or materials, to be added to the contaminated mix or blend to allow the ability of the contaminated mix or blend to provide an environment of encapsulation of contaminated materials and also permanently close voids.

9. The contaminated-mix or blend allows industry a permanent process and remedy to permanently place contaminated material into structures that are at the surface or below the surface with a depository as define by CERCLA and Superfund laws and rules, the United States Environment Protection Agency or any Federal Respondent to permanently place contaminated material as defined by the EPA or any other governmental agency a means and remedy to permanently close mines, shafts or voids with contaminated materials as a useful product and return that site back to a useful purpose.
